(19) United States
(12) Patent Application Publication
(10) Pub. No.: US 2025/0057123 A1
(43) Pub. Date: Feb. 20, 2025

(54) ANIMAL TRAINING TOOL

(71) Applicant: Sebastian PODZAMECER, ARIEL (IL)

(72) Inventor: Sebastian PODZAMECER, ARIEL (IL)

(21) Appl. No.: 18/765,269

(22) Filed: Jul. 7, 2024

Related U.S. Application Data
(60) Provisional application No. 63/532,911, filed on Aug. 16, 2023.

(51) Int. Cl. A01K 15/02

(52) U.S. Cl. CPC A01K 15/025

(57) ABSTRACT

A training tool for an animal, the tool including a cylindrical compartment, including a front opening, for inserting cylindrical shaped food therethrough, and a handle, for sliding the cylindrical shaped food along the cylindrical compartment.

### CROSS-REFERENCE TO RELATED APPLICATIONS

This application claims the benefit of U.S. Provisional Patent Application No. 63/532,911 filed Aug. 16, 2023, the disclosure of which is incorporated herein by reference.

### TECHNICAL FIELD

The invention relates to the field of dogs training. More particularly, the invention relates to an tool for feeding during training.

### BACKGROUND

To train dogs today, for example, dried snacks made of meat are used that are given to the dog during training. It is necessary to prepare in advance a certain amount of snacks in a certain container. There is a problem in transferring each snack to the dog's mouth during training, because the dog may accidentally bite the hand that gives him the snack.

A hot dog is more effective than using snacks. The trainer may hold a fresh hot dog/sausage and allow the dog to bite a part of the hot dog during training. The method of training with the hot dog is effective, but there are several problems with it, for example, holding the hot dog in the hand is not pleasant, leaves a smell on the hand and makes the hand dirty with a greasy substance. It is difficult for the trainer to determine during training what size of a piece of hot dog the dog will be allowed to receive and eat whenever it is up to the dog at the discretion of the trainer to receive a prize of a piece of hot dog. There is the unpleasantness of biting the dog by mistake on the hand of the trainer.

There is a long-felt need to provide a solution to the above-mentioned and other problems of the prior art.

### SUMMARY

The invention, in embodiments thereof, provides a training tool including a cylindrical compartment and a handle for sliding a sausage along the cylindrical compartment.

### BRIEF DESCRIPTION OF THE DRAWINGS

Embodiments, features, and aspects of the invention are described herein in conjunction with the following drawings in which:

FIG. 1 depicts a training tool according to one embodiment of the invention;

FIG. 2 depicts the training tool of FIG. 1, containing a sausage, and the use thereof;

FIG. 3 depicts the training tool of FIG. 1, containing the sausage, and the state ready

for feeding;

FIG. 4 depicts the training tool of FIG. 1, the end of the sausage eaten, and the first step of preparing to feed;

FIG. 5 depicts second step of preparing to feed;

FIG. 6 depicts third step of preparing to feed;

FIG. 7 depicts fourth step of preparing to feed;

FIG. 8 depicts a problem regarding FIG. 5;

FIG. 9 depicts FIG. 5 including an additional element for solving the problem depicted in FIG. 8;

FIG. 10 is a front view of the tool; and

FIG. 11 is a front perspective view of the tool.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

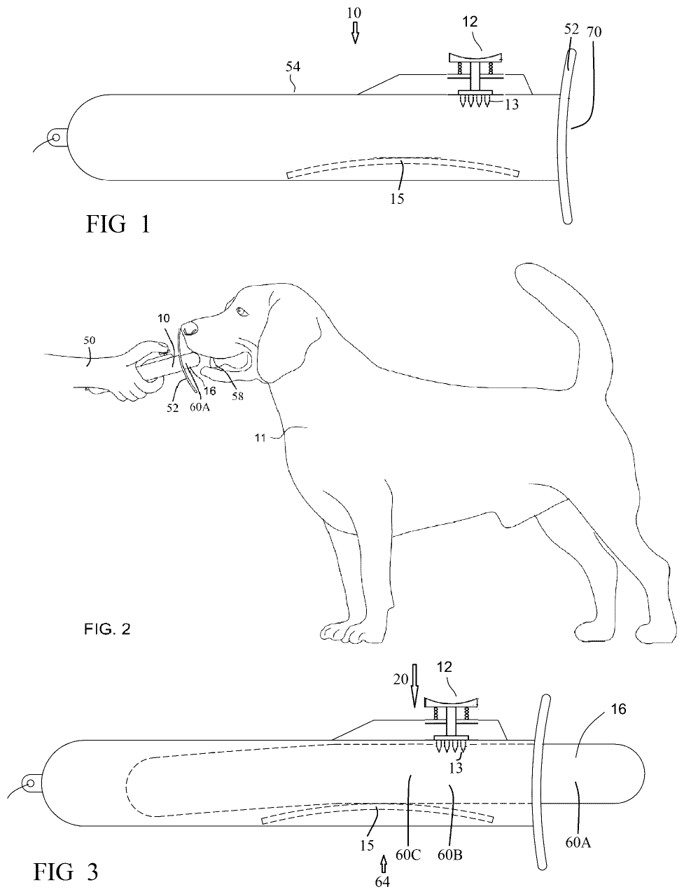

FIG. 1 is a side view of a training tool according to one embodiment.

A training tool 10 according to one embodiment, includes a cylindrical compartment 54 being open at the front (70); a springy leaf reed 15 within compartment 54; a handle 12 disposed outside compartment 54; and spikes 13 extending from handle 12 directed towards leaf reed 15, into compartment.

FIG. 2 depicts the training tool of FIG. 1, containing a sausage, and the use thereof.

Training tool 10 is used for being held by a hand 50 of a user, typically a dog trainer, for allowing a dog 11, eat the end 60A only of a sausage 16 after being inserted into compartment 54, while not allowing dog 11 eat the rest, and while protecting hand 50 of the user from the dog's teeth, such as by a guarding partition 52 surrounding the front of compartment 54.

Training tool 10 is advantaged of eliminating smell to the trainer's hand; eliminates fats of the food or the sausage from being held by the trainer; protects the trainer from the dog's bite; provides the trainer with accuracy of the eaten amount, being a significant factor of the training, e.g., small amount to small good behavior; being amount to big good behavior. Training tool 10 is “green” since it eliminates using gloves and plastic waste.

FIG. 3 depicts the training tool of FIG. 1, containing the sausage, and the state ready for feeding.

At the state ready for feeding, end 60A extends out of compartment 54; and spikes 13 are thrust by pressing 20 on handle 12 to the top of the center 60B of sausage 16.

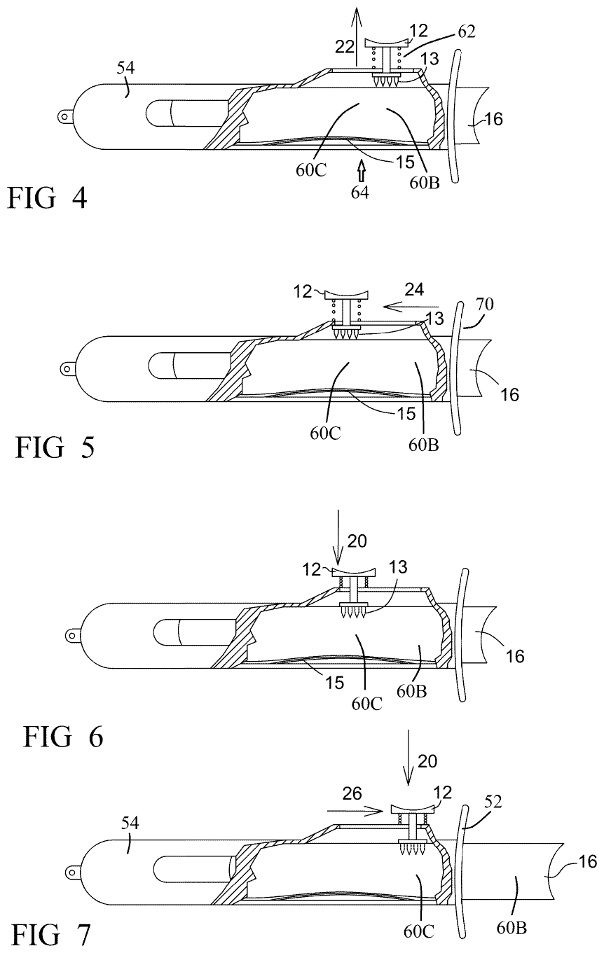

FIG. 4 depicts the training tool of FIG. 1, the end of the sausage eaten, and the first step of preparing to feed.

End 60A is shown cut due to the eating by the dog.

The user may then release handle 12 and spring 62 lifts (22) handle 12 and spikes 13, for canceling the thrusting. At this state, pressure 64 provided by leaf reed 15 produces friction force between compartment 54 and sausage 16, for avoiding slipping of sausage 16 outside.

FIG. 5 depicts second step of preparing to feed.

Then while spikes 13 are not thrust, the user slides (24) handle 12 together with spikes 13 away from the front, to be disposed above the left (60C) of sausage 16.

FIG. 6 depicts third step of preparing to feed.

The user then presses (20) handle 12 to thrust spikes 13 into the left zone (60C) of sausage 16.

FIG. 7 depicts fourth step of preparing to feed.

Then, while pressing (20) handle 12, to maintain the thrusting by spikes 13 into the left zone (60C) of sausage 16, the user slides (26) handle 12 together with spikes 13 towards from partition 52, thus exiting zone 60B outside compartment 54 and beyond wall being available to eat.

FIG. 4 and FIG. 5 assume that spikes 13 are not thrust upon releasing handle 12.

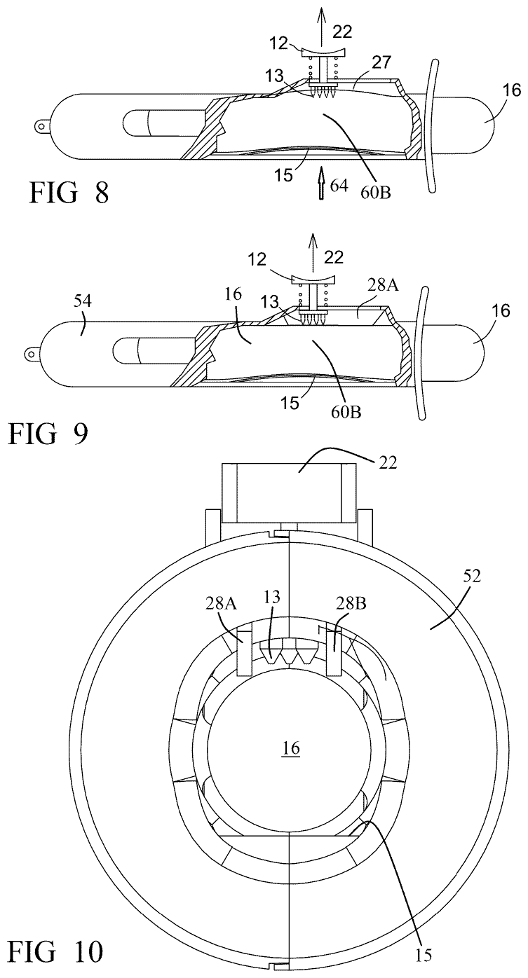

FIG. 8 depicts a problem regarding FIG. 5.

However, pressure 64 provided by leaf reed 15, which bends sausage 16 (shown in FIG. 3), tends as well to bend (27) zone 60B of sausage 16 onto spikes 13.

FIG. 9 depicts FIG. 5 including an additional element for solving the problem depicted in FIG. 8.

A stationary protrusion 28A within compartment 54 is fixed within and along compartment 54, against leaf reed 15, for avoiding the bending (27 of FIG. 8) of sausage 16 onto spikes 13 by leaf reed 15.

FIG. 10 is a front view of the tool.

A stationary protrusion 28B within compartment 54 is fixed within and along compartment 54, against leaf reed 15, for avoiding the bending (27 of FIG. 8) of sausage 16 onto spikes 13 disposed between stationary protrusions 28A and 28B.

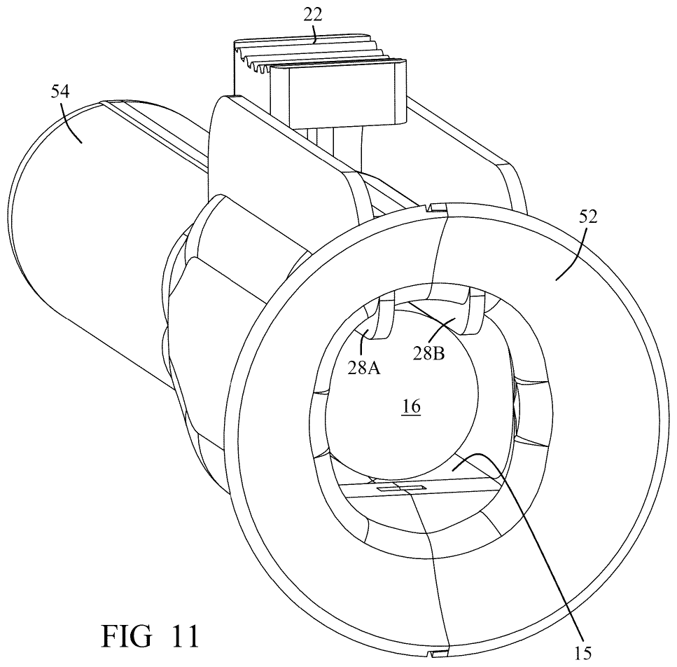

FIG. 11 is a front perspective view of the tool.

Thus, in one aspect, the invention is directed to a training tool (10) for an animal (11), the tool including:
a cylindrical compartment (54), including a front opening (70), for inserting cylindrical shaped food (16) therethrough; and
a handle (12), for sliding the cylindrical shaped food (16) along the cylindrical compartment (54).

The training tool (10) may further include a partition (52) disposed near the opening (70), for avoiding access to the animal, to a rear of the partition (52).

The training tool (10) may further include at least one spike (13) extending from the handle (12) into the compartment (54), the at least one spike (13) for thrusting thereof by the handle (12) into the cylindrical shaped food (16), and for canceling the thrusting.

The training tool (10) may further include a springy leaf read (15) fixed to the compartment (54) therewithin, for pressing (64) the cylindrical shaped food (16) onto an inner wall of the compartment (54).

The training tool (10) may further include two protrusions (28A,28B) fixed to the compartment (54) therewithin and therealong.

The training tool (10) may further include at least one spike (13) extending from the handle (12) into the compartment (54) between the two protrusions (28A,28B).

In the figures and description herein, the following reference numbers (Reference Signs List) have been mentioned:
number 10 denotes the animal training tool according to one embodiment of the invention;
11: animal, typically a dog;
12: handle;
13: spikes;
15: springy leaf reed;
16: cylindrical shaped food, typically sausage;
20: pressing on handle 12;
22: lifting of handle 12;
24: sliding forth;
26: sliding back;
27: bending of a zone of sausage 16;
28A,28B: protrusions;
50: user's hand;
52: external partition;
54: cylindrical compartment;
58: teeth;
60A,60B,60C: zones of sausage 16;
62: spring;
64: pressure;
70: opening of cylindrical compartment 54;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. An animal training tool, the tool comprising:
an elongated compartment, comprising a front opening, for inserting elongated shaped food therethrough; and
a handle, for sliding said elongated shaped food along said cylindrical compartment.

2. The training tool according to claim 1, further comprising a partition disposed near said opening, for avoiding access to the animal, to a rear of said partition.

3. The training tool according to claim 1, further comprising at least one spike extending from said handle into said compartment, said at least one spike for thrusting said elongated shaped food, and for canceling said thrusting.

4. The training tool according to claim 1, further comprising a springy leaf read fixed to said compartment therewithin, for pressing said elongated shaped food onto an inner wall of said compartment.

5. The training tool according to claim 1, further comprising two protrusions fixed to said compartment therewithin and therealong.

6. The training tool according to claim 5, further comprising at least one spike extending from said handle into said compartment between said two protrusions.
